(19) United States
(12) Patent Application Publication
(10) Pub. No.: US 2026/0222801 A1
(43) Pub. Date: Jul. 30, 2026

(54) METHODS FOR UPDATING KEY, COMMUNICATION DEVICE, AND STORAGE MEDIUM

(71) Applicant: Beijing Xiaomi Mobile Software Co., Ltd., Beijing (CN)

(72) Inventors: Haoran LIANG, Beijing (CN); Wei LU, Beijing (CN)

(21) Appl. No.: 19/146,145

(22) PCT Filed: Jan. 8, 2023
(86) PCT No.: PCT/CN2023/071149

§ 371 Date: Jul. 7, 2025

(51) Int. Cl. H04W 12/04; H04L 9/08

(52) U.S. Cl. CPC H04W 12/04; H04L 9/0891

(57) ABSTRACT

A method for updating a key, including: generating a first key based on first information in a case where the terminal device is connected to a secondary node (SN), where the first information is updatable by the terminal device, and the first key is configured to: establish a reconnection with the SN using the first key when the terminal device reconnects to the SN after disconnecting from a current connection with the SN; and sending the first key to the SN.

### CROSS-REFERENCE TO RELATED APPLICATION

The present application is a U.S. National Stage of International Application No. PCT/CN2023/071149, filed on Jan. 8, 2023, the contents of all of which are incorporated herein by reference in their entireties for all purposes.

### BACKGROUND OF THE INVENTION

Generally, in a communication system, a terminal device typically performs condition-based switching between candidate primary secondary cells (PSCells) managed by different secondary nodes (SNs) to enable selective activation of secondary cell groups (SCGs). Generally, the terminal device needs to establish a connection with an SN based on an updated key when it switches a connection with the SN each time.

### SUMMARY OF THE INVENTION

The present disclosure relates to the technical field of communications, and in particular, to a method for updating a key, a communication device, and a storage medium.

According to a first aspect, an embodiment of the present disclosure provides a method for updating a key, including:
generating a first key based on first information in a case where a terminal device is connected to a secondary node (SN), where the first information is updatable by the terminal device, and the first key is configured to: establish a reconnection with the SN using the first key when the terminal device reconnects to the SN after disconnecting from a current connection with the SN; and
sending the first key to the SN.

According to a second aspect, an embodiment of the present disclosure provides a method for updating a key, including:
receiving a first key sent by a terminal device in a case where the SN is connected to the terminal device, where the first key is configured to: establish a reconnection with the terminal device using the first key when the terminal device reconnects to the SN after disconnecting from a current connection with the SN.

According to a third aspect, an embodiment of the present disclosure provides a communication device. The communication device includes one or more processors and a memory, where the memory stores a computer program, and the one or more processors are collectively configured to execute the computer program stored in the memory to enable the communication device to implement the method according to the first aspect or the second aspect.

According to a fourth aspect, an embodiment of the present disclosure provides a non-transitory computer-readable storage medium, configured to store instructions used by above terminal device, where the instructions, when executed, causes the terminal device to perform the method according to the first aspect or the second aspect.

### BRIEF DESCRIPTION OF DRAWINGS

The following descriptions of embodiments with reference to accompanying drawings make the at least one of above or additional aspects and benefits of the present disclosure apparent and easy to understand.

FIG. 1 is a schematic architectural diagram of a communication system according to an embodiment of the present disclosure.

FIG. 2 is a schematic flowchart of a method for updating a key according to another embodiment of the present disclosure.

FIG. 3 is a schematic flowchart of a method for updating a key according to another embodiment of the present disclosure.

FIG. 4 is a schematic flowchart of a method for updating a key according to another embodiment of the present disclosure.

FIG. 5 is a schematic flowchart of a method for updating a key according to another embodiment of the present disclosure.

FIG. 6 is a schematic flowchart of a method for updating a key according to another embodiment of the present disclosure.

FIG. 7 is a schematic flowchart of a method for updating a key according to another embodiment of the present disclosure.

FIG. 8 is a schematic flowchart of a method for updating a key according to another embodiment of the present disclosure.

FIG. 9 is a schematic flowchart of a method for updating a key according to another embodiment of the present disclosure.

FIG. 10 is a schematic flowchart of a method for updating a key according to another embodiment of the present disclosure.

FIG. 11 is a schematic flowchart of a method for updating a key according to another embodiment of the present disclosure.

FIG. 12 is a schematic flowchart of a method for updating a key according to another embodiment of the present disclosure.

FIG. 13 is a schematic flowchart of a method for updating a key according to another embodiment of the present disclosure.

FIG. 14 is a schematic flowchart of a method for updating a key according to another embodiment of the present disclosure.

FIG. 15 is a schematic flowchart of a method for updating a key according to another embodiment of the present disclosure.

FIG. 16 is a schematic flowchart of a method for updating a key according to another embodiment of the present disclosure.

FIG. 17 is a schematic flowchart of a method for updating a key according to another embodiment of the present disclosure.

FIG. 18 is a schematic flowchart of a method for updating a key according to another embodiment of the present disclosure.

FIG. 19 is a schematic flowchart of a method for updating a key according to another embodiment of the present disclosure.

FIG. 20 is a schematic flowchart of a method for updating a key according to another embodiment of the present disclosure.

FIG. 21a is an interaction flowchart of a method for updating a key according to an embodiment of the present disclosure.

FIG. 21b is an interaction flowchart of another method for updating a key according to an embodiment of the present disclosure.

FIG. 22a is an interaction flowchart of another method for updating a key according to an embodiment of the present disclosure.

FIG. 22b is an interaction flowchart of another method for updating a key according to an embodiment of the present disclosure.

FIG. 23 is a schematic structural diagram of a communication device according to an embodiment of the present disclosure.

FIG. 24 is a schematic structural diagram of a communication device according to another embodiment of the present disclosure.

FIG. 25 is a schematic structural diagram of a communication device according to another embodiment of the present disclosure.

FIG. 26 is a schematic structural diagram of a chip according to an embodiment of the present disclosure.

### DETAILED DESCRIPTION OF THE INVENTION

Examples are described in detail below, and are shown in the accompanying drawings. In the description below, unless otherwise indicated, the same reference numerals in different drawings refer to the same or similar elements. Implementations described in the following examples are not intended to represent all implementations consistent with the embodiments of the present disclosure. On the contrary, they are merely examples of the devices and methods consistent with some aspects of the embodiments of the present disclosure as described in detail in the appended claims.

The terms used in the embodiments of the present disclosure are merely for the purpose of describing specific embodiments, and are not intended to limit the embodiments of the present disclosure. The singular forms “a/an,” and “the” used in the embodiments of the present disclosure and the appended claims are also intended to include plural forms, unless otherwise specified in the context clearly. It is also understandable that the term “and/or” used in the specification includes any or all possible combinations of one or more associated listed items.

It is understandable that although the terms “first,” “second,” “third,” and the like may be used in the embodiments of the present disclosure to describe various information, the information are not limited by these terms. The terms are merely configured to distinguish between same types of signals. For example, first information may also be referred to as second information, and similarly, second information may also be referred to as first information, without departing from the scope of the embodiments of the present disclosure. The word “if” and “when” as used herein may be interpreted as “in a case where” or “upon” or “in response to determining”, depending on the context.

Embodiments of the present disclosure are described in detail below. Examples of the embodiments are shown in the accompanying drawings, and the same or similar reference numerals refer to the same or similar elements throughout the accompanying drawings. The embodiments described below with reference to the accompanying drawings are illustrative and are intended to explain the present disclosure, rather than being construed as limiting the present disclosure.

No method for updating a key, applicable to a selective SCG activation scenario (i.e., a scenario where the SN needs to be switched for a plurality of times), exists currently. The present disclosure provides a method and device for updating a key, a device, and a storage medium, which are suitable for updating the generated a key configured to establish a connection with an SN in a selective SCG activation scenario.

Referring to FIG. 1, a schematic architectural diagram of a communication system according to an embodiment of the present disclosure is illustrated. The communication system may include, but not limited to, an SN 101, a master node (MN) 102, and a terminal device 103. Optionally, the number and types of the device shown in FIG. 1 are used for illustrative purposes and are not construed as limiting the embodiment of the present disclosure. In actual applications, the communication system may include one or more SNs, one or more MNs, or one or more terminal devices. Optionally, as an example, the communication system shown in FIG. 1 includes one SN, one MN, and one terminal device.

It is to be noted that the technical solutions in the embodiments of the present disclosure are applicable to various types of communication systems, such as a long term evolution (LTE) system, a 5th generation (5G) mobile communications system, a new radio (NR) system, and other future novel mobile communication system.

The terminal device in the embodiments of the present disclosure may be a user-side entity configured to receive or transmit a signal, such as a mobile phone. The terminal device may also be referred to as a terminal, user equipment (UE), a mobile station (MS), a mobile terminal (MT), or the like. The terminal device may be a vehicle having a communication function, a smart vehicle, a mobile phone, a wearable device, a tablet computer (Pad), a computer with a wireless transceiving function, a virtual reality (VR) terminal device, an augmented reality (AR) terminal device, a wireless terminal device in industrial control, a wireless terminal device in self-driving, a wireless terminal device in remote medical surgery, a wireless terminal device in smart grid, a wireless terminal device in transportation safety, a wireless terminal device in smart city, a wireless terminal device in smart home, or the like. The specific technology and physical form used by the UE are not limited in the embodiments of the present disclosure.

The MN or SN in the embodiments of the present disclosure may be a network-side entity configured to transmit or receive a signal. For example, the MN or SN may be an evolved NodeB (eNB), a transmission reception point (TRP), a next generation NodeB (gNB) in an NR system, a base station in other future mobile communication systems, or an access node in a wireless fidelity (Wi-Fi) system. The specific technology and physical form used by the network device are not limited in the embodiments of the present disclosure. The MN or SN provided in the embodiments of the present disclosure may include a central unit (CU) and a distributed unit (DU). The CU may also be referred to as control unit. A protocol layer of a network device, such as a base station, may be split using a CU-DU structure. Some functions of the protocol layer may be centrally controlled by the CU, while the remaining or all functions of the protocol layer are distributed in the DU, where the DU is centrally controlled by the CU.

It is understandable that the communication system described in the embodiments of the present disclosure is provided to describe technical solutions of the embodiments of the present disclosure more clearly, and is not construed as limiting the technical solutions provided in the embodiments of the present disclosure. Those of ordinary skill in the art may know that with the evolution of system architectures and the emergence of new service scenarios, the technical solutions provided in the embodiments of the present disclosure are also applicable to similar technical problems.

A method and device for updating a key, a device, and a storage medium provided in the embodiments of the present disclosure are described below in detail with reference to the accompanying drawings.

It is to be noted that in the present disclosure, the method for updating the key provided in any one embodiment may be performed independently. Similarly, any implementation in the embodiment may be performed independently, performed in combination with other embodiments, performed with possible implementations in other embodiments, or performed in conjunction with any technical solution known in the related art.

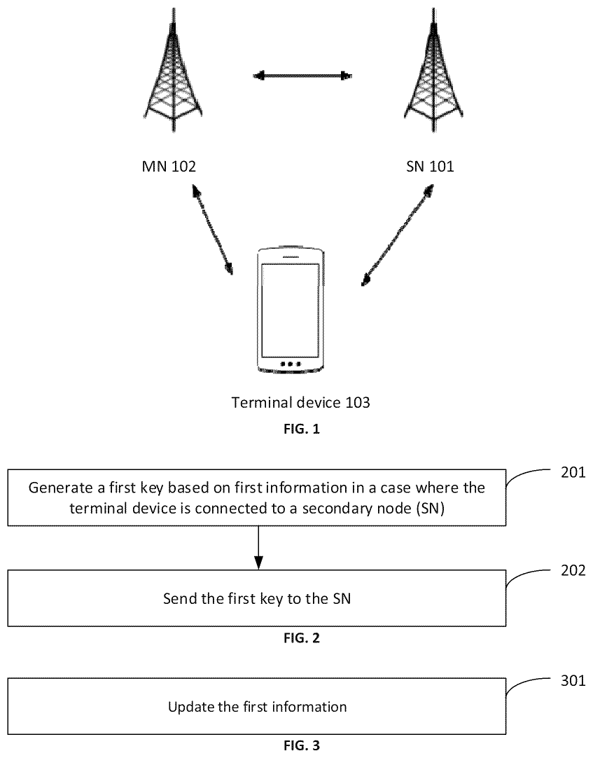

FIG. 2 is a schematic flowchart of a method for updating a key according to an embodiment of the present disclosure. The method is performed by a terminal device. As shown in FIG. 2, the method for updating the key may include the following steps.

Step 201: a first key is generated based on first information in a case where the terminal device is connected to a secondary node (SN).

Optionally, in one embodiment of the present disclosure, the first key may be configured to establish a reconnection with the SN using the first key when the terminal device reconnects to the SN after disconnecting from a current connection with the SN. In other words, in one embodiment of the present disclosure, the terminal device generates the first key for reconnecting to the SN next time in a case where the terminal device is connected to the SN, allowing to establish a reconnection with the SN based on the first key, in a case where the terminal device needs to be reconnected to the SN later.

In one embodiment of the present disclosure, at least one of the following are performed: the first information may be configured by a master node (MN) to the terminal device, or the first information may be generated by the terminal device itself.

Optionally, in some embodiments, the first information may include at least one of:
an SN identity, where the SN identity may be configured by the MN to the terminal device, the MN may configure an SN identity of at least one SN to the terminal device, and the at least one SN may be: an SN to which the terminal device may be connected later, for example, an SN for managing a candidate PSCell;
a count value of a first counter, where the first counter may be configured by the MN to the terminal device, the MN may configure a respective first counter for the at least one SN, and first counters corresponding to different SNs may be the same or different, for example, initial count values of the first counters corresponding to different SNs may be the same or different;
a second key, where the second key may be generated by the terminal device based on the first counter and the SN identity; or
a count value of a second counter, where the second counter may be generated by the terminal device itself, the terminal device may generate a respective second counter for the at least one SN; and second counters corresponding to different SNs may be the same or different, for example, initial count values of the second counters corresponding to different SNs may be the same or different.

In some embodiments, the terminal device may generate the first key based on the SN identity, the count value of the first counter, the second key, and the count value of the second counter as described above. In some other embodiments, the terminal device may generate the first key based on the count value of the first counter and the count value of the second counter as described above.

Optionally, in some other embodiments, the first information may include at least one of:
the SN identity; or
the count value of the first counter.

In some embodiments, the terminal device may generate the first key based on the SN identity and the count value of the first counter as described above. In some other embodiments, the terminal device may generate the first key based on the count value of the first counter as described above.

Optionally, in one embodiment of the present disclosure, the first information is updatable by the terminal device. For example, the terminal device may update the first information after generating the first key based on the first information. The updated first information may be configured to re-update the generated first key based on the updated first information when the terminal device reconnects to the SN after disconnecting from a current connection with the SN.

It is to be noted that content, updatable by the terminal device, in the first information may vary, in a case where the content included in the first information varies. Specifically, in one embodiment of the present disclosure, in a case where the first information includes the count value of the second counter, the content, updatable by the terminal device, in the first information refers to the count value of the second counter in the first information, for example, the first information may be updated by adding a fixed value (such as 1) to the count value of the second counter. In another embodiment of the present disclosure, in a case where the first information does not include the count value of the second counter but includes the count value of the first counter, the content, updatable by the terminal device, in the first information refers to the count value of the first counter in the first information, for example, the first information may be updated by adding a fixed value (such as 1) to the count value of the first counter.

Optionally, in one embodiment of the present disclosure, since the MN may update a configured first counter to the terminal device later after configuration of the first counter, the terminal device may send the updated count value of the first counter to the MN, in a case where content updated by the terminal device is the count value of the first counter. This allows the MN to be aware of a current count value updated by the terminal device for the first counter. When updating, by the MN, the configured first counter to the terminal device later, the count value of the configured first counter, updated by the MN, needs to be a value that has not been counted by the terminal device for the first counter. In other words, the count value of the configured first counter, updated by the MN, is to be greater than a current count value updated by the terminal device for the first counter.

For example, assuming that the terminal device has updated the count value of the first counter to 2, the terminal device reports to the MN that the current count value of the first counter is 2. The count value of the configured first counter to be updated is to be greater than 2, such as 3, in a case where the MN needs to update the configured first counter for the terminal device.

In addition, for other details about updating the configured first counter by the MN for the terminal device, reference may be made to content of an embodiment of FIG. 3 described below.

Optionally, in one embodiment of the present disclosure, generating the first key based on the first information may include at least one of:

Method 1: The first key is generated based on the first information before the terminal device releases the connection with the SN.

Method 2: The first key is generated based on the first information in a case where a connection release request sent by the SN is received by the terminal device.

Optionally, the connection release request may be sent by the SN to the terminal device when the number of transmissions of any link (such as an uplink or a downlink) between the SN and the terminal device reaches a pre-defined threshold. Specifically, both the uplink and the downlink between the SN and the terminal device respectively corresponds to packet data convergence protocol (PDCP) counters. Each time a transmission occurs over a link, the PDCP counter corresponding to the link is updated (for example, adding 1). In a case where a count value of the PDCP counter of any link (such as at least one of an uplink or a downlink of an SCG data radio bearer (DRB)) of the SN reaches the pre-defined threshold, or a count value of the PDCP counter of at least one of an uplink or a downlink of an SCG signal radio bearer (SRB)) of the SN reaches the pre-defined threshold, the SN sends the connection release request to the terminal device.

As can be learned from the above that in one embodiment of the present disclosure, a first key is generated based on first information each time the terminal device is connected to an SN. In addition, the first information may be updated after the first key is generated. This ensures that the first key generated for the next connection with the SN is different upon connecting the terminal to the SN each time. As a result, the used first key is different upon reconnecting the terminal device to the SN each time, ensuring updating of the first key.

Step 202: the first key is sent to the SN.

Optionally, in one embodiment of the present disclosure, the terminal device notifies the SN of content of the first key by sending the first key to the SN. This allows the SN to establish a reconnection with the terminal device based on the first key upon reconnecting the terminal device to the SN next time.

Optionally, in one embodiment of the present disclosure, the terminal device may send at least one of an identity of the terminal device corresponding to the first key or key indication information corresponding to the first key to the SN.

The identity of the terminal device may indicate: which terminal device is reconnected by the SN using the first key. For example, the identity of the terminal device may be at least one of a subscription permanent identifier (SUPI) of the terminal device, a subscription concealed identifier (SUCI) of the terminal device, an IMS privacy user identity (IMPI) of the terminal device, an application layer ID of the terminal device, or a generic public subscription identifier (GPSI) of the terminal device.

The key indication information may instruct the SN to establish the reconnection with the terminal device based on the first key upon requesting, by the terminal device, the reconnection with the SN. In a case where the SN receives the key indication information, the SN may establish the reconnection with the terminal based on the first key corresponding to the terminal device when the terminal device indicated by the key indication information needs to be reconnected to the SN. For example, the key indication information may be at least one of a key identifier or an SCG activation indicator.

Based on the above content, an example of the procedure for updating the key in embodiments of the present disclosure is as examples.

For example, assuming that the terminal device establishes a current connection with an SN #1, and the first information is first information #1, the terminal device may generate a first key #1 based on the first information #1, and send the first key #1 to the SN #1, where the first key #1 may be configured to establish a connection with the SN based on the first key #1 upon reconnecting the terminal device to the SN #1 next time. After the terminal device generates the first key #1, first information #2 may be obtained by updating the first information #1, where updating the first information #1 maybe, for example, as follows: the first information #2 may be obtained by adding 1 to the count value of the second counter in the first information #1, in a case where the first information #1 includes the count value of the second counter; or the first information #2 may be obtained by adding 1 to the count value of the first counter in the first information #1, in a case where the first information #1 does not include the count value of the second counter but includes the count value of the first counter.

In addition, assuming that the terminal device releases the connection with the SN #1, switches to an SN #2, and then needs to switch back to the SN #1, the terminal device may establish a reconnection with the SN #1 based on the previously generated first key #1. After the terminal device establishes the reconnection with the SN #1 based on the first key #1, the terminal device may update the generated first key #2 based on the first information #2 that is obtained previously by updating, and send it to the SN, where the first key #2 may be configured to establish a connection with the SN based on the first key #2 upon reconnecting the terminal device to the SN #1 next time. After generating the first key #2 based on the first information #2, the terminal device may obtain first information #3 by updating content of the first information #2. Through such cycles, this ensures that first keys used upon reconnecting the terminal device to the SN each time is different, enabling the updating of the first key.

In summary, in the method for updating the key according to the embodiment of the present disclosure, the terminal device may generate the first key based on the first information in a case where the terminal device is connected to the SN, where the first information is updatable by the terminal device, and the first key may be configured to establish the reconnection with the SN using the first key when the terminal device reconnects to the SN after disconnecting from a current connection with the SN. Subsequently, the terminal device sends the first key to the SN. As can be learned that in the method of the present disclosure, the terminal device generates, based on the first information, the first key for a next reconnection, and sends the first key to the SN, under the current connection between the terminal device and the SN. In addition, since the first information is updatable by the terminal device, the first key generated, by the terminal device, for a next reconnection may be different each time. As a result, the terminal device may use an updated first key to establish the reconnection with the SN when the terminal device is reconnected to the SN each time. The method for updating the key in the present disclosure may be suitable for updating the generated keys configured to connect SNs in a scenario (such as a selective SCG activation scenario) where SNs are switched for a plurality of times by the terminal device, ensuring stable execution of selective SCG activation.

FIG. 3 is a schematic flowchart of a method for updating a key according to an embodiment of the present disclosure. The method is performed by a terminal device. As shown in FIG. 3, the method for updating the key may include the following step:

Step 301: the first information is updated.

Optionally, in one embodiment of the present disclosure, the updated first information may be configured to: update the generated first key based on the updated first information when the terminal device reconnects to the SN after disconnecting from a current connection with the SN.

Optionally, in one embodiment of the present disclosure, the terminal device may update the first information after generating the first key.

The detailed description of step 301 may be referred to the foregoing embodiments, and is not repeated in the present disclosure.

In summary, in the method for updating the key according to the embodiment of the present disclosure, the terminal device updates the first information configured to generate the first key. This ensures that the first key generated by the terminal device for the next reconnection is different each time, allowing the terminal device to establish the reconnection with the SN using the updated first key, upon reconnecting the terminal device to the SN. The method for updating the key in the present disclosure may be suitable for updating the generated keys configured to connect SNs in a scenario (such as a selective SCG activation scenario) where the SNs are switched for a plurality of times by the terminal device, ensuring stable execution of selective SCG activation.

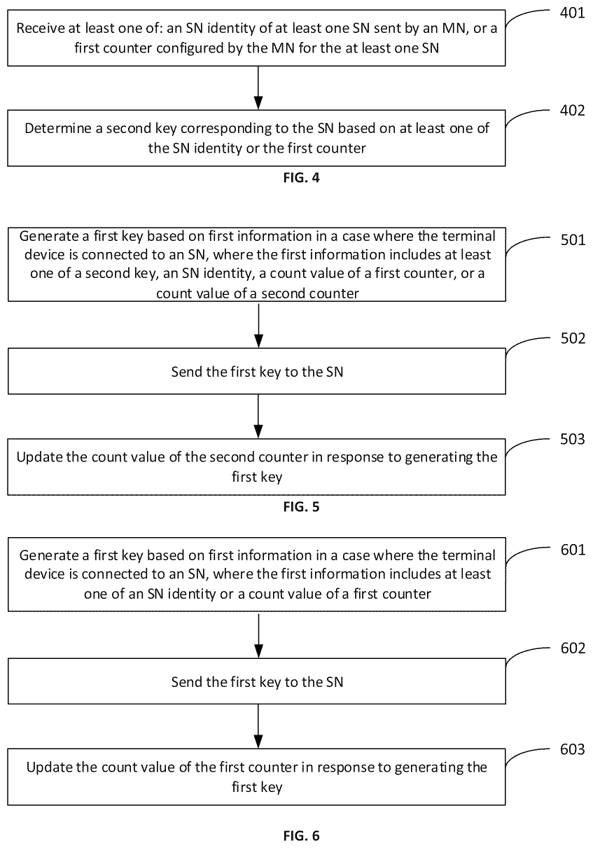

FIG. 4 is a schematic flowchart of a method for updating a key according to an embodiment of the present disclosure. The method is performed by a terminal device. As shown in FIG. 4, the method for updating the key may include the following steps.

Step 401: at least one of the following is received: an SN identity of at least one SN sent by an MN, or a first counter configured by the MN for the at least one SN.

Optionally, in one embodiment of the present disclosure, the at least one SN may be: an SN to which the terminal device may be connected later, such as an SN managing a candidate PSCell. Additionally, first counters corresponding to different SNs may be the same or different, for example, initial count values of the first counters corresponding to different SNs may be the same or different.

Step 402: a second key corresponding to the SN is determined based on at least one of the SN identity or the first counter.

Optionally, the terminal device may determine a second key corresponding to the SN based on the SN identity and the count value of the first counter. Optionally, the terminal device may alternatively determine a second key corresponding to the SN based on the count value of the first counter.

Optionally, in one embodiment of the present disclosure, the first counter may be configured by the MN to the terminal device before initial connection of the terminal device to the SN, or may alternatively be updated and configured by the MN to the terminal device after the terminal device has already connected to the SN. In addition, in one embodiment of the present disclosure, each time the MN configures the first counter to the terminal device, the MN also calculates the second key based on at least one of the SN identity or the first counter configured by the MN, and sends the second key to the corresponding SN, allowing the SN to obtain the same second key synchronous with the terminal device. Optionally, the MN may determine the second key corresponding to the SN based on the SN identity and the count value of the first counter. Optionally, the MN may alternatively determine the second key corresponding to the SN based on the count value of the first counter.

Optionally, in one embodiment of the present disclosure, in a case where the first counter is configured by the MN to the terminal device before initial connection of the terminal device to the SN, the terminal device may implement the initial connection with the SN based on the second key. The SN identity, the first counter, and the second key may be further configured to generate the first information. For example, the first information may be constructed based on at least one of the SN identity, the count value of the first counter, the second key, or a count value of a second counter generated by the terminal device, and then, the first information is updated by updating the count value of the second counter. Alternatively, the first information may be constructed based on at least one of the SN identity or the count value of the first counter, and then, the first information is updated by updating the count value of the first counter.

In another embodiment of the present disclosure, in a case where the configured first counter is updated by the MN to the terminal device after the terminal device has already connected to the SN, the terminal device is supposed to establish the reconnection with the SN based on “the second key determined by updating the configured first counter by the MN” rather than based on the first key, upon reconnecting the terminal device to the SN next time after the updated first counter is received. In addition, the terminal device may update the generated first information based on at least one of the SN identity or the first counter updated by the MN. For example, the first information may be updated and constructed based on at least one of the SN identity, the count value of the configured first counter updated by the MN, the second key determined according to the configured first counter updated by the MN, or the count value of the second counter generated by the terminal device, and then, the first information is updated by updating the count value of the second counter. Optionally, in one embodiment of the present disclosure, upon receiving, by the terminal device, the updated first counter by the MN, the terminal device may initialize the count value of the second counter, for example, initialize the count value to an initial count value just generated by the terminal device for the second counter.

Alternatively, in another embodiment of the present disclosure, the terminal device may update and construct the first information based on at least one of the SN identity or the count value of the configured first counter updated by the MN, and then, the first information is updated by updating the count value of the configured first counter updated by the MN.

The following provides an example of the execution process in a case where the terminal device receives the first counter configured by the MN.

For example, assuming that the terminal device receives at least one of an identity of an SN #1 or the first counter #1 configured by the MN before initial connection with the SN #1, the terminal device may generate a second key #1 based on the at least one of identity of the SN #1 or the first counter #1, and establish the initial connection based on the second key #1 and the SN #1. Subsequently, the terminal device may determine first information #1 based on at least one of the identity of the SN #1 or the first counter #1 configured by the MN. For example, the terminal device may generate the second counter, and constructs the first information #1 using at least one of the SN #1, the count value of the first counter #1, the second key #1, or a count value of the second counter, or the terminal device may construct the first information #1 using at least one of the SN #1 or the count value of the first counter #1. Afterward, the terminal device generates a first key #1 based on the first information #1, and obtains first information #2 by updating content of the first information #1 after generating the first key #1. For example, in a case where the first information #1 includes the count value of the second counter, the first information #1 may be updated by updating the count value of the second counter. Alternatively, in a case where the first information #1 does not include the count value of the second counter but includes the count value of the first counter #1, the first information #1 may be updated by updating the count value of the first counter #1. Subsequently, assuming that the terminal releases the connection with the SN #1, switches to be connected to an SN #2 and then needs to be reconnected to the SN #1, the terminal device may establish a first reconnection with the SN #1 based on the previously generated first key #1.

Moreover, assuming that after the terminal device establishes the first reconnection with the SN #1, the terminal device obtains a configured first counter #2 updated by the MN. A count value of the first counter #2 is different from the count value of the first counter #1. In this case, the terminal device may generate a second key #2 based on at least one of the identity of the SN #1 or the first counter #2, discard the previously updated first information #2, and re-generate first information #3 based on at least one of the identity of the SN #1 or the first counter #2 (the specific method for generating the first information #3 may be referred to the previous content). Subsequently, when the terminal device releases the connection with the SN #1 and needs to be reconnected to the SN #1, the terminal device is supposed to establish a second reconnection with the SN #1 based on the second key #2. Once the terminal device establishes the second reconnection with the SN #1 based on the second key #2, the terminal device may generate a first key #3 based on the first information #3, allowing to establish a connection with the SN #1 based on the first key #3 upon reconnecting to the SN #1 at the third time. Moreover, after generating the first key #3, the terminal device may update the first information #3 (the specific method for updating may be referred to the previous content).

In summary, the method for updating the key provided in the embodiment of the present disclosure may be suitable for updating the generated keys configured to connect SNs in a scenario where the SNs are switched for a plurality of times by the terminal device (such as a selective SCG activation scenario), ensuring stable execution of selective SCG activation.

FIG. 5 is a schematic flowchart of a method for updating a key according to an embodiment of the present disclosure. The method is performed by a terminal device. As shown in FIG. 5, the method for updating the key may include the following steps.

Step 501: a first key is generated based on first information in a case where the terminal device is connected to an SN, where the first information includes at least one of a second key, an SN identity, a count value of a first counter, or a count value of a second counter.

Step 502: the first key is sent to the SN.

Step 503: the count value of the second counter is updated in response to generating the first key.

The detailed descriptions about steps 501-503 may be referred to the description of the foregoing embodiments.

In summary, the method for updating the key provided in the embodiment of the present disclosure may be suitable for updating the generated keys configured to connect SNs in a scenario (such as a selective SCG activation scenario) where the SNs are switched for a plurality of times by a terminal device, ensuring stable execution of selective SCG activation.

FIG. 6 is a schematic flowchart of a method for updating a key according to an embodiment of the present disclosure. The method is performed by a terminal device. As shown in FIG. 6, the method for updating the key may include the following steps.

Step 601: a first key is generated based on first information in a case where the terminal device is connected to an SN, where the first information includes at least one of an SN identity or a count value of a first counter.

Step 602: the first key is sent to the SN.

Step 603: the count value of the first counter is updated in response to generating the first key.

The detailed descriptions about steps 601-603 may be referred to the description of the foregoing embodiments.

In summary, the method for updating the key provided in the embodiment of the present disclosure may be suitable for updating the generated keys configured to connect SNs in a scenario (such as a selective SCG activation scenario) where the SNs are switched for a plurality of times by the terminal device, ensuring stable execution of selective SCG activation.

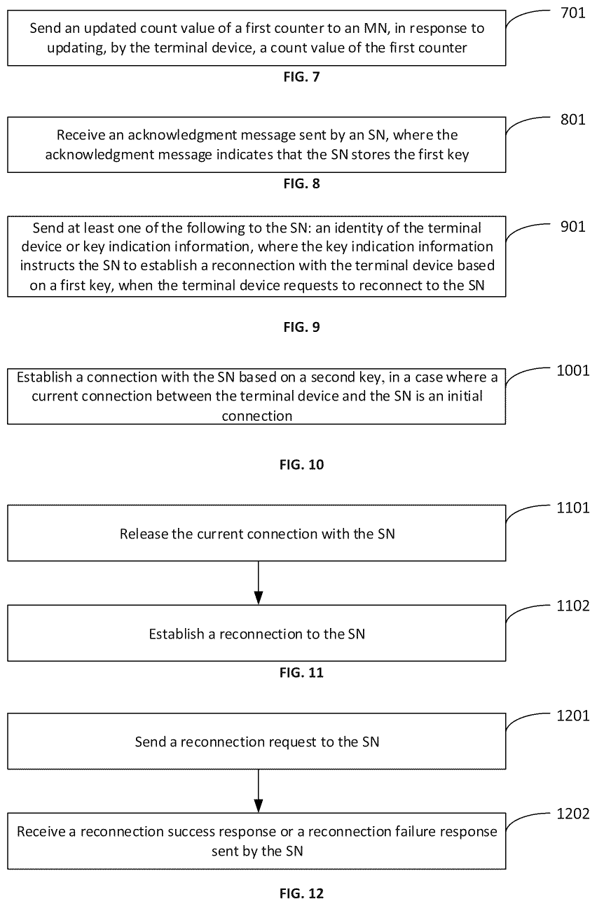

FIG. 7 is a schematic flowchart of a method for updating a key according to an embodiment of the present disclosure. The method is performed by a terminal device. As shown in FIG. 7, the method for updating the key may include the following step.

Step 701: an updated count value of a first counter is sent to an MN, in response to updating, by the terminal device, a count value of the first counter.

Optionally, in one embodiment of the present disclosure, since the MN may update a configured first counter to the terminal device later after configuration of the first counter, the terminal device may send the updated count value of the first counter to the MN, in a case where content updated by the terminal device is the count value of the first counter. This allows the MN to be aware of a current count value updated by the terminal device for the first counter. When updating, by the MN, the configured first counter to the terminal device later, the count value of the configured first counter, updated by the MN, needs to be a value that has not been counted by the terminal device for the first counter. In other words, the count value of the configured first counter, updated by the MN, is to be greater than a current count value updated by the terminal device for the first counter.

The detailed descriptions about step 701 may be referred to the description of the foregoing embodiments.

In summary, the method for updating the key provided in the embodiment of the present disclosure may be suitable for updating the generated keys configured to connect SNs in a scenario (such as a selective SCG activation scenario) where the SNs are switched for a plurality of times by the terminal device, ensuring stable execution of selective SCG activation.

FIG. 8 is a schematic flowchart of a method for updating a key according to an embodiment of the present disclosure. The method is performed by a terminal device. As shown in FIG. 8, the method for updating the key may include the following step.

Step 801: an acknowledgment message sent by an SN is received, where the acknowledgment message indicates that the SN stores the first key.

The detailed description about step 801 may be referred to the description of the foregoing embodiments.

In summary, the method for updating the key provided in the embodiment of the present disclosure may be suitable for updating the generated keys configured to connect SNs in a scenario (such as a selective SCG activation scenario) where the SNs are switched for a plurality of times by the terminal device, ensuring stable execution of selective SCG activation.

FIG. 9 is a schematic flowchart of a method for updating a key according to an embodiment of the present disclosure. The method is performed by a terminal device. As shown in FIG. 9, the method for updating the key may include the following step.

Step 901: at least one of the following is sent to the SN: an identity of the terminal device or key indication information, where the key indication information instructs the SN to establish a reconnection with the terminal device based on a first key, when the terminal device requests to reconnect to the SN.

The detailed description about step 901 may be referred to the description of the foregoing embodiments.

In summary, the method for updating the key provided in the embodiment of the present disclosure may be suitable for updating the generated keys configured to connect SNs in a scenario (such as a selective SCG activation scenario) where the SNs are switched for a plurality of times by the terminal device, ensuring stable execution of selective SCG activation.

FIG. 10 is a schematic flowchart of a method for updating a key according to an embodiment of the present disclosure. The method is performed by a terminal device. As shown in FIG. 10, the method for updating the key may include the following step.

Step 1001: a connection with the SN is established based on a second key, in a case where a current connection between the terminal device and the SN is an initial connection.

The detailed description about step 1001 may be referred to the description of the foregoing embodiments.

In summary, the method for updating the key provided in the embodiment of the present disclosure may be suitable for updating the generated keys configured to connect SNs in a scenarios (such as a selective SCG activation scenario) where the SNs are switched for a plurality of times by the terminal device, ensuring stable execution of selective SCG activation.

FIG. 11 is a schematic flowchart of a method for updating a key according to an embodiment of the present disclosure. The method is performed by a terminal device. As shown in FIG. 11, the method for updating the key may include the following steps.

Step 1101: the current connection with the SN is released.

Optionally, in one embodiment of the present disclosure, the terminal device may autonomously determine to release the current connection with the SN, or the terminal device may release the current connection with the SN based on a connection release request sent by the SN.

Step 1102: a reconnection to the SN is established.

Optionally, in one embodiment of the present disclosure, reconnection to the SN is established may include at least one of:
reconnection with the SN is established based on a first key, in a case where the first counter is configured by the MN to the terminal device before a previous connection between the terminal device and the SN is established; or
reconnection with the SN is established based on a second key, in a case where the first counter is configured by the MN to the terminal device after the previous connection between the terminal device and the SN is established, where the second key is determined by the terminal device based on at least one of a count value of the first counter or the identity of the SN configured by the MN.

The detailed description about steps 1101-1102 may be referred to the description of the embodiment of FIG. 3.

In summary, the method for updating the key provided in the embodiment of the present disclosure may be suitable for updating the generated keys configured to connect SNs in a scenario (such as a selective SCG activation scenario) where the SNs are switched for a plurality of times by the terminal device, ensuring stable execution of selective SCG activation.

FIG. 12 is a schematic flowchart of a method for updating a key according to an embodiment of the present disclosure. The method is performed by a terminal device. The method according to the embodiment of FIG. 12 is used to describe the process where “the terminal device establishes the reconnection with the SN based on the first key”. As shown in FIG. 12, the method may include the following steps.

Step 1201: a reconnection request is sent to the SN.

Optionally, the reconnection request may include at least one of:
an identity of the terminal device;
key indication information, where the key indication information instructs the SN to establish the reconnection with the terminal device based on the first key, when the terminal device requests to reconnect to the SN; or
second information, where the second information is configured for the SN to implement integrity verification.

Optionally, in one embodiment of the present disclosure, the second information may be information obtained after the terminal device calculates at least one of the identity of the terminal device or the key indication information based on the first key. For example, the second information may be a MAC value obtained after calculating at least one of the identity of the terminal device or the key indication information based on the first key. Optionally, upon receiving the reconnection request by the SN, the fact that a connection with the terminal device needs to be established based on the first key may be determined based on the key indication information in the reconnection request. In this case, the SN may obtain processed information by determining a corresponding first key based on the identity of the terminal device and processing the second information based on the first key (for example, performing inverse operation on the second information), where the processed information may be at least one of the identity of the terminal device or the key indication information obtained by restoring the second information. Subsequently, the SN may compare whether the processed information is consistent with at least one of the identity of the terminal device or the key indication information included in the reconnection request. Integrity verification is determined as success in a case of consistency, or integrity verification is determined as failure in a case of no consistency.

Step 1202: a reconnection success response or a reconnection failure response sent by the SN is received.

In summary, the method for updating the key provided in the embodiment of the present disclosure may be suitable for updating the generated keys configured to connect SNs in a scenario (such as a selective SCG activation scenario) where the SNs are switched for a plurality of times by the terminal device, ensuring stable execution of selective SCG activation.

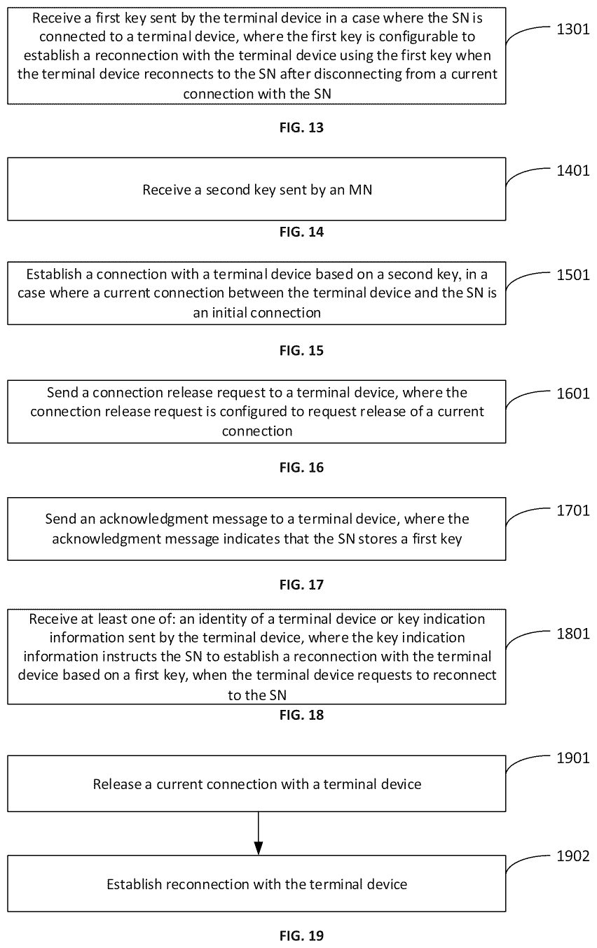

FIG. 13 is a schematic flowchart of a method for updating a key according to an embodiment of the present disclosure. The method is performed by an SN. As shown in FIG. 13, the method may include the following step.

Step 1301: a first key sent by the terminal device is received in a case where the SN is connected to a terminal device, where the first key may be configured to establish a reconnection with the terminal device using the first key when the terminal device reconnects to the SN after disconnecting from a current connection with the SN.

The detailed description about step 1301 may be referred to the description of the foregoing embodiments.

In summary, the method for updating the key provided in the embodiment of the present disclosure may be suitable for updating the generated keys configured to connect SNs in a scenario (such as a selective SCG activation scenario) where the SNs are switched for a plurality of times by the terminal device, ensuring stable execution of selective SCG activation.

FIG. 14 is a schematic flowchart of a method for updating a key according to an embodiment of the present disclosure. The method is performed by an SN. As shown in FIG. 14, the method may include the following step.

Step 1401: a second key sent by an MN is received.

The detailed description about step 1401 may be referred to the description of the foregoing embodiments.

In summary, the method for updating the key provided in the embodiment of the present disclosure may be suitable for updating the generated keys configured to connect SNs in a scenario (such as a selective SCG activation scenario) where the SNs are switched for a plurality of times by the terminal device, ensuring stable execution of selective SCG activation.

FIG. 15 is a schematic flowchart of a method for updating a key according to an embodiment of the present disclosure. The method is performed by an SN. As shown in FIG. 15, the method may include the following step.

Step 1501: a connection with a terminal device is established based on a second key, in a case where a current connection between the terminal device and the SN is an initial connection.

The detailed description about step 1501 may be referred to the description of the foregoing embodiments.

In summary, the method for updating the key provided in the embodiment of the present disclosure may be suitable for updating the generated keys configured to connect SNs in a scenario (such as a selective SCG activation scenario) where the SNs are switched for a plurality of times by the terminal device, ensuring stable execution of selective SCG activation.

FIG. 16 is a schematic flowchart of a method for updating a key according to an embodiment of the present disclosure. The method is performed by an SN. As shown in FIG. 16, the method may include the following step.

Step 1601: a connection release request is sent to a terminal device, where the connection release request is configured to request release of a current connection.

The detailed description about step 1601 may be referred to the description of the foregoing embodiments.

In summary, the method for updating the key provided in this embodiment of the present disclosure may be suitable for updating the generated keys configured to connect SNs in a scenario (such as a selective SCG activation scenario) where the SNs are switched for a plurality of times by the terminal device, ensuring stable execution of selective SCG activation.

FIG. 17 is a schematic flowchart of a method for updating a key according to an embodiment of the present disclosure. The method is performed by an SN. As shown in FIG. 17, the method may include the following step.

Step 1701: an acknowledgment message is sent to a terminal device, where the acknowledgment message indicates that the SN stores a first key.

The detailed description about step 1701 may be referred to the description of the foregoing embodiments.

In summary, the method for updating the key provided in the embodiment of the present disclosure may be suitable for updating the generated keys configured to connect SNs in a scenario (such as a selective SCG activation scenario) where the SNs are switched for a plurality of times by the terminal device, ensuring stable execution of selective SCG activation.

FIG. 18 is a schematic flowchart of a method for updating a key according to an embodiment of the present disclosure. The method is performed by an SN. As shown in FIG. 18, the method may include the following step.

Step 1801: at least one of the following is received: an identity of a terminal device or key indication information sent by the terminal device, where the key indication information instructs the SN to establish a reconnection with the terminal device based on a first key when the terminal device requests to reconnect to the SN.

The detailed description about step 1801 may be referred to the description of the foregoing embodiments.

In summary, the method for updating the key provided in the embodiment of the present disclosure may be suitable for updating the generated keys configured to connect SNs in a scenario (such as a selective SCG activation scenario) where the SNs are switched for a plurality of times by the terminal device, ensuring stable execution of selective SCG activation.

FIG. 19 is a schematic flowchart of a method for updating a key according to an embodiment of the present disclosure. The method is performed by an SN. As shown in FIG. 19, the method may include the following steps.

Step 1901: a current connection with a terminal device is released.

Step 1902: reconnection with the terminal device is established.

Optionally, reconnection with the terminal device may include at least one of:
reconnection with the SN is established based on a first key, in a case where a second key is sent to the SN by an MN before a previous connection between the terminal device and the SN is established; or
reconnection with the SN is established based on the second key, in a case where the second key is sent to the SN by the MN after the previous connection between the terminal device and the SN is established.

The detailed description about steps 1901-1902 may be referred to the description of the foregoing embodiments.

In summary, the method for updating the key provided in the embodiment of the present disclosure may be suitable for updating the generated keys configured to connect SNs in a scenario (such as a selective SCG activation scenario) where the SNs are switched for a plurality of times by the terminal device, ensuring stable execution of selective SCG activation.

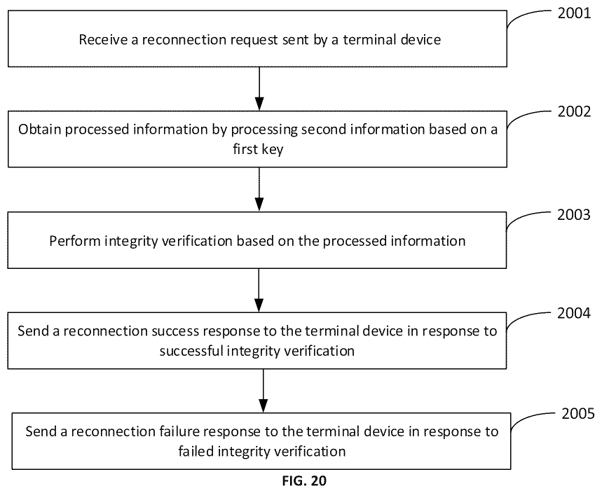

FIG. 20 is a schematic flowchart of a method for updating a key according to an embodiment of the present disclosure. The method is performed by an SN. As shown in FIG. 20, the method may include the following steps.

Step 2001: a reconnection request sent by a terminal device is received.

Optionally, the reconnection request includes at least one of: an identity of the terminal device, key indication information, or second information, where the key indication information instructs the SN to establish the reconnection with the terminal device based on the first key, when the terminal device requests to reconnect to the SN, and the second information is used by the SN to perform integrity verification.

Step 2002: processed information is obtained by processing second information based on a first key.

Step 2003: integrity verification is performed based on the processed information.

Step 2004: a reconnection success response is sent to the terminal device in response to successful integrity verification.

Step 2005: a reconnection failure response is sent to the terminal device in response to failed integrity verification.

The detailed description about steps 2001-2005 may be referred to the description of the foregoing embodiments.

In summary, the method for updating the key provided in the embodiment of the present disclosure may be suitable for updating the generated keys configured to connect SNs in a scenario (such as a selective SCG activation scenario) where the SNs are switched for a plurality of times by the terminal device, ensuring stable execution of selective SCG activation.

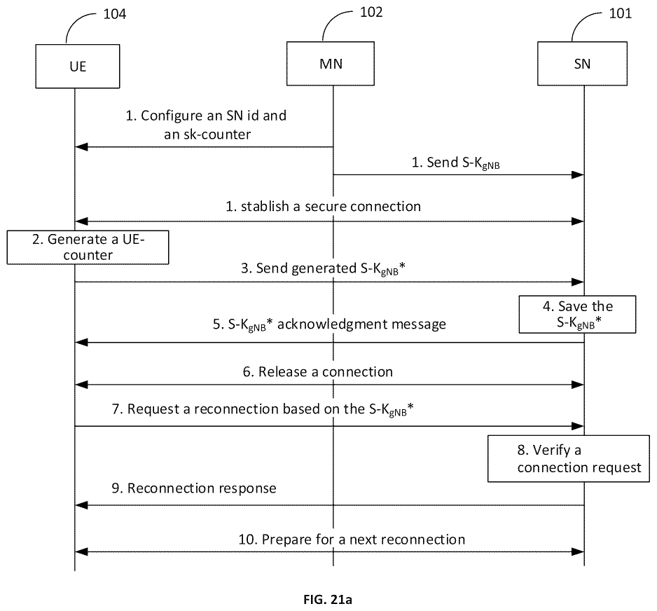

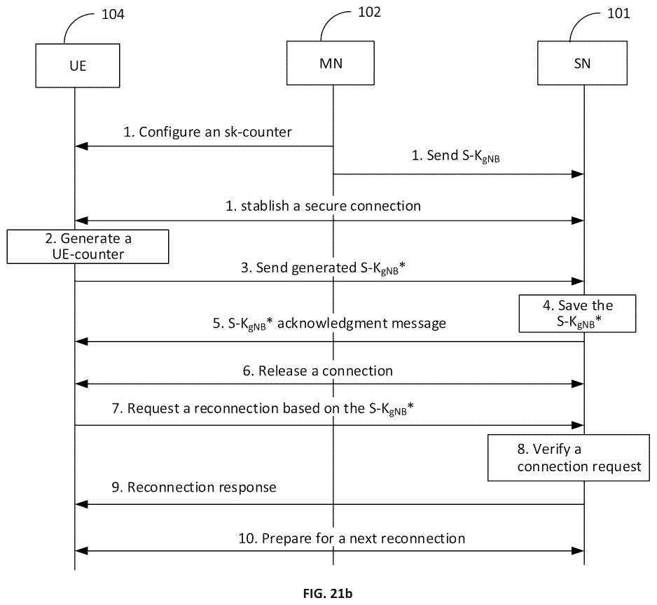

FIG. 21a is an interaction flowchart of a method for updating a key according to an embodiment of the present disclosure. The following describes, by using an example with reference to FIG. 21a, an interaction process of the method for updating the key. As shown in FIG. 21a, the interaction process of the method for updating the key includes the following steps.

1. An MN 102 sends an SN id and an sk-counter (namely, the first counter described above) to UE 104 (namely, the terminal device described above), where SNs 101 and SN ids are in a one-to-one correspondence, and the SNs 101 and sk-counters are in a one-to-one correspondence. Different SNs correspond to different SN ids, and different SNs correspond to the same sk-counter or different sk-counters. The MN 102 and the UE 104 obtain S-K_{gNB} (namely, the second key described above) corresponding to an SN 101 based on the sk-counter and the SN id that uniquely identifies the SN. In addition, the MN 102 sends the newly obtained S-K_{gNB} to the SN 101. As a result, the UE 104 and the SN 101 may establish a secure connection based on the S-K_{gNB}.

2. S-K_{gNB}* (namely, the first key described above) is calculated based on the S-K_{gNB}, the sk-counter, the SN id, and a UE-counter (namely, the second counter described above). The UE 104 generates the UE-counter before releasing a connection between the UE 104 and the SN 101. A value ‘0’ of the UE-counter is configured to calculate first S-K_{gNB}*. The UE 104 is supposed to set the UE-counter to ‘1’ after first calculation of S-K_{gNB}*, and monotonically increase the value of each additionally calculated S-K_{gNB}*. The S-K_{gNB}* is calculated when the UE attempts to reconnect to the SN 101 in a selective SCG activation scenario. The UE-counter is reset to ‘0’ upon obtaining of the sk-counter. When at least one of uplink or downlink PDCP counts of any SCG DRB or SCG SRB are about to wrap around, the SN 101 requests the UE to update the S-K_{gNB}*.

3. In order to reconnect to the SN 101 in a selective SCG activation scenario, the UE sends the newly derived S-K_{gNB}* to the SN 101 via a secure connection. The UE 104 may send its SUCI or a key identifier to the SN 101. The key identifier may trigger the SN 101 to protect a subsequent connection in the selective SCG activation scenario using the S-K_{gNB}*.

4. The SN 101 stores the S-K_{gNB}*. The SN 101 may store the S-K_{gNB}* and the SUCI or the key identifier. The SN 101 is supposed to replace the used S-K_{gNB}* with a newly received S-K_{gNB}*, in a case where the used S-K_{gNB}* is stored in the SN 101.

5. The SN 101 confirms to the UE 104 that the S-K_{gNB}* has been stored.

6. The connection between the SN 101 and the UE 104 is released.

7. The UE 104 attempts to reconnect to the SN 101 in the selective SCG activation scenario. The UE 104 sends a connection request to an SN 101 protected by the S-K_{gNB}*. The connection request may include the SUCI or the key identifier. The request further includes a selective SCG activation indicator, where the selective SCG activation indicator triggers the SN 101 to use the S-K_{gNB}* rather than the S-K_{gNB}.

8. The SN 101 verifies integrity of the request based on the S-K_{gNB}*, upon receiving the selective SCG activation indicator or the key identifier. The S-K_{gNB}* is identified using the SUCI or the key identifier. The SN 101 is supposed to terminate the connection, in response to failure of the requested integrity verification.

9. The SN 101 sends a connection response to the UE 104.

10. The UE 104 and the SN 101 may prepare parameters for a next connection using step 2 to step 5, in a case where a secure connection between the SN 101 and the UE 104 has been established.

FIG. 21b is an interaction flowchart of another method for updating a key according to an embodiment of the present disclosure. The following describes, by using an example with reference to FIG. 21b, an interaction process of the method for updating the key. As shown in FIG. 21b, the interaction process of the method for updating the key includes the following steps.

1. An MN 102 sends an sk-counter (namely, the first counter described above) to UE 104 (namely, the terminal device described above), where SNs 101 and sk-counters are in a one-to-one correspondence, and different SNs correspond to different sk-counters. The MN 102 and the UE 104 obtain S-K_{gNB} (namely, the second key described above) corresponding to the SN based on the sk-counter. In addition, the MN 102 sends the newly obtained S-K_{gNB} to the SN 101. As a result, the UE 104 and the SN 101 may establish a secure connection based on the S-K_{gNB}.

2. S-K_{gNB}* (namely, the first key described above) is calculated based on the sk-counter and a UE-counter (namely, the second counter described above). The S-K_{gNB}* (namely, the first key described above) may be calculated based on the UE-counter (namely, the second counter described above). The UE 104 generates the UE-counter before releasing a connection between the UE 104 and the SN 101.

3. In order to reconnect to the SN 101 in a selective SCG activation scenario, the UE 104 sends the newly derived S-K_{gNB}* to the SN 101 via a secure connection. The UE 104 may send its SUCI or a key identifier to the SN 101. The key identifier may trigger the SN 101 to protect a subsequent connection in the selective SCG activation scenario using the S-K_{gNB}*.

4. The SN 101 stores the S-K_{gNB}*. The SN 101 may store the S-K_{gNB}* and the SUCI or the key identifier. The SN 101 is supposed to replace the used S-K_{gNB}* with a newly received S-K_{gNB}*, in a case where the used S-K_{gNB}* is stored in the SN 101.

5. The SN 101 confirms to the UE 104 that the S-K_{gNB}* has been stored.

6. The connection between the SN 101 and the UE 104 is released.

7. The UE 104 attempts to reconnect to the SN 101 in the selective SCG activation scenario. The UE 104 sends a connection request to an SN 101 protected by the S-K_{gNB}*. The connection request may include the SUCI or the key identifier. The request further includes a selective SCG activation indicator, where the selective SCG activation indicator triggers the SN 101 to use the S-K_{gNB}* rather than the S-K_{gNB}.

8. The SN 101 verifies integrity of the request based on the S-K_{gNB}*, upon receiving the selective SCG activation indicator or the key identifier. The S-K_{gNB}* is identified using the SUCI or the key identifier. The SN 101 is supposed to terminate the connection, in response to failure of the requested integrity verification.

9. The SN 101 sends a connection response to the UE 104.

10. The UE 104 and the SN 101 may prepare parameters for a next connection using step 2 to step 5, in a case where a secure connection between the SN 101 and the UE 104 has been established.

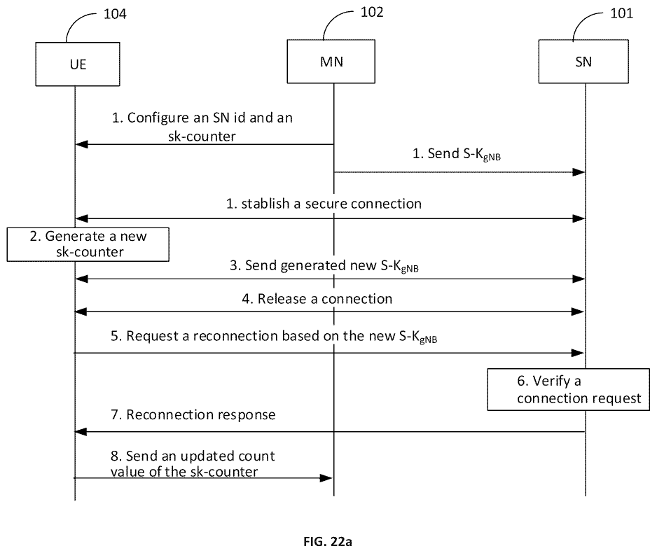

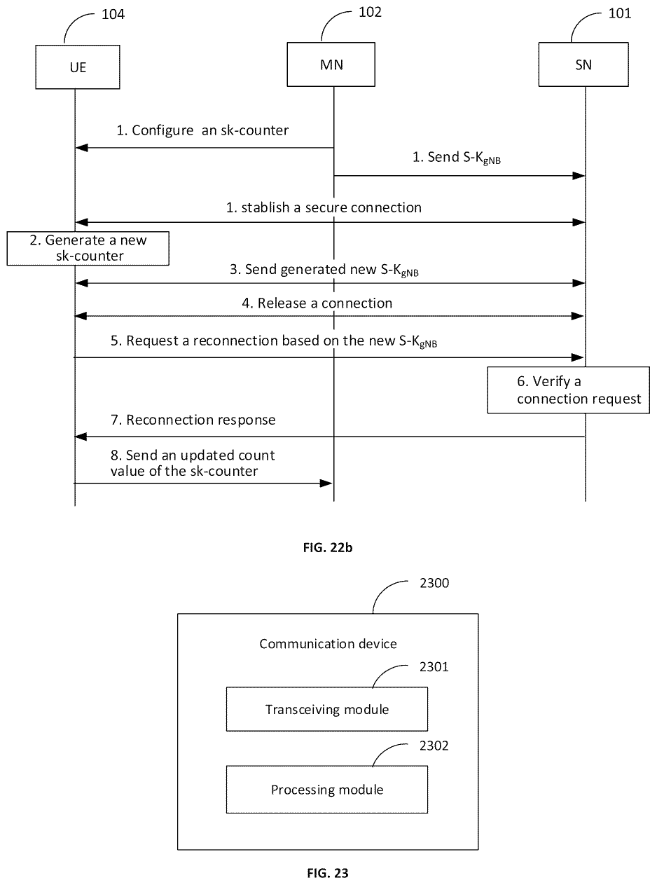

FIG. 22a is an interaction flowchart of another method for updating a key according to an embodiment of the present disclosure. The following describes, by using an example with reference to FIG. 22a, an interaction process of the method for updating the key. As shown in FIG. 22a, the interaction process of the method for updating the key includes the following steps.

1. An MN 102 sends an SN 101 id and an sk-counter (namely, the first counter described above) to UE 104 (namely, the terminal device described above), where SNs and SN ids are in a one-to-one correspondence, and the SNs and sk-counters are in a one-to-one correspondence. Different SNs correspond to different SN ids, and different SNs correspond to the same sk-counter or different sk-counters. The MN 102 and the UE 104 derive S-K_{gNB} corresponding to an SN based on the sk-counter and the SN id that uniquely identifies the SN. In addition, the MN 102 sends the newly derived S-K_{gNB} (namely, the second key described above) to the SN 101. As a result, the UE 104 and the SN 101 may establish a secure connection based on the S-K_{gNB}.

2. The UE 104 generates a new sk-counter (namely, the above-described count value of the first counter updated by the terminal device), used in a later connection with the SN 101 in a selective SCG activation scenario. Specifically, the UE 104 updates the sk-counter by monotonically increasing the count value. The UE 104 generates a new S-K_{gNB} (namely, the first key described above) based on the updated sk-counter and the SN id.

3. The UE 104 sends the new S-K_{gNB} to the SN 101. The UE 104 may send its SUCI or key identifier to the SN 101. The SN 101 is supposed to replace an original S-K_{gNB} with the new S-K_{gNB}.

4. The secure connection between the UE 104 and the SN 101 is released.

5. The UE 104 protects a connection request message using the new S-K_{gNB}. The UE 104 is supposed to protect using S-K_{gNB} related to the sk-counter that is sent by the MN 102, in a case where the MN 102 sends the sk-counter to the UE 104 after the generation process of the new S-K_{gNB}.

6. The SN 101 verifies integrity of the connection request message using the new S-K_{gNB}. The SN 101 is supposed to verify using the S-K_{gNB} sent by the MN 102, in a case where the MN 102 sends S-K_{gNB} to the SN 101 before connection establishment. The SN 101 is supposed to terminate the connection, in response to failure of the requested integrity verification.

7. The SN 101 sends a connection response to the UE 104.

8. The UE 104 sends updated sk-counter to the MN 102. The MN 102 is supposed to further update the sk-counter based on the sk-counter from the UE 104.

FIG. 22b is an interaction flowchart of another method for updating a key according to an embodiment of the present disclosure. The following describes, by using an example with reference to FIG. 22b, an interaction process of the method for updating the key. As shown in FIG. 22b, the interaction process of the method for updating the key includes the following steps.

1. An MN 102 sends an sk-counter (namely, the first counter described above) to UE 104 (namely, the terminal device described above), where SNs and sk-counters are in a one-to-one correspondence, and different SNs correspond to different sk-counters. The MN 102 and the UE 104 derive S-K_{gNB} corresponding to the SN 101 based on the sk-counter. In addition, the MN 102 sends the newly derived S-K_{gNB} (namely, the second key described above) to the SN 101. As a result, the UE 104 and the SN 101 may establish a secure connection based on the S-K_{gNB}.

2. The UE 104 generates a new sk-counter (namely, the above-described count value of the first counter updated by the terminal device), used in a later connection with the SN 101 in a selective SCG activation scenario. Specifically, the UE 104 updates the sk-counter by monotonically increasing the count value. The UE 104 generates a new S-K_{gNB} (namely, the first key described above) based on the updated sk-counter.

3. The UE 104 sends the new S-K_{gNB} to the SN 101. The UE 104 may also send its SUCI or key identifier to the SN 101. The SN 101 is supposed to replace an original S-K_{gNB} with the new S-K_{gNB}.

4. The secure connection between the UE 104 and the SN 101 is released.

5. The UE 104 protects a connection request message using the new S-K_{gNB}. The UE 104 is supposed to protect using S-K_{gNB} related to the sk-counter that is sent by the MN 102, in a case where the MN 102 sends the sk-counter to the UE 104 after the generation process of the new S-K_{gNB}.

6. The SN 101 verifies integrity of the connection request message using the new S-K_{gNB}. The SN 101 is supposed to verify using the S-K_{gNB} sent by the MN 102, in a case where the MN 102 sends the S-K_{gNB} to the SN 101 before connection establishment. The SN 101 is supposed to terminate the connection, in response to failure of the requested integrity verification.

7. The SN 101 sends a connection response to the UE 104.

8. The UE 104 sends updated sk-counter to the MN 102. The MN 102 is supposed to further update the sk-counter based on the sk-counter from the UE 104.

Optionally, the UE is supposed to be able to calculate S-K_{gNB}*. The S-K_{gNB}* is calculated based on K_{gNB}, the sk-counter, an SN id, and a UE-counter. The UE is supposed to be able to generate the UE-counter before releasing a connection between the UE and the SN. A value ‘0’ of the UE-counter is configured to calculate first S-K_{gNB}*. The UE is supposed to set the sk-counter to ‘1’ after first calculation of the S-K_{gNB}*, and monotonically increase the value of each additional calculation of S-K_{gNB}*. The UE-counter is reset to ‘0’, upon obtaining the sk-counter. The UE is supposed to be able to send the newly derived S-K_{gNB}* to the SN via a secure connection. The UE may send its SUCI or key identifier to the SN. In a selective SCG activation scenario, the UE is supposed to be able to protect a connection request to the SN using the S-K_{gNB}*. The request further includes a selective SCG activation indicator, where the selective SCG activation indicator triggers the SN to connect in a selective SCG activation scenario using the S-K_{gNB}* rather than the S-K_{gNB}. The key identifier/selective SCG activation indicator may trigger the SN to protect a connection in the selective SCG activation scenario using the S-K_{gNB}*.

Optionally, the SN is supposed to be able to receive the S-K_{gNB}* from the UE. When at least one of uplink or downlink PDCP counts are about to wrap around for any SCG DRB or SCG SRB, the SN is supposed to be able to request the UE to update the S-K_{gNB}*. The SN is supposed to be able to verify integrity of a request based on the S-K_{gNB}*. The SN is supposed to be able to select S-K_{gNB}* to verify integrity of the request message based on the key identifier/selective SCG activation indicator.

Optionally, the MN is supposed to be able to derive S-K_{gNB} based on the sk-counter and the SN id that uniquely identifies the SN. The MN is supposed to be able to send the SN id to the UE.

FIG. 23 is a schematic structural diagram of a communication device according to an embodiment of the present disclosure. As shown in FIG. 23, the communication device 2300 may include:
a processing module 2302, configured to generate a first key based on first information in a case where a terminal device is connected to an SN, where the first key may be configured to: establish a reconnection with the SN using the first key when the terminal device reconnects to the SN after disconnecting from a current connection with the SN; and
a transceiving module 2301, configured to send the first key to the SN.

In summary, according to the communication device provided in the embodiment of the present disclosure, the terminal device may generate the first key based on the first information in a case where the terminal device is connected to the SN, where the first information is updatable by the terminal device, and the first key may be configured to: establish the reconnection with the SN using the first key when the terminal device reconnects to the SN after disconnecting from a current connection with the SN. Subsequently, the terminal device sends the first key to the SN. As can be learned that in the method of the present disclosure, the terminal device generates, based on the first information, the first key for a next reconnection, and sends the first key to the SN, under the current connection between the terminal device and the SN. In addition, since the first information is updatable by the terminal device, the first key generated, by the terminal device, for a next reconnection may be different each time. As a result, the terminal device may use an updated first key to establish the reconnection with the SN when the terminal device is reconnected to the SN each time. The method for updating the key in the present disclosure may be suitable for updating the generated keys configured to connect SNs in a scenario (such as a selective SCG activation scenario) where SNs are switched for a plurality of times by the terminal device, ensuring stable execution of selective SCG activation.

Optionally, in one embodiment of the present disclosure, the device is further configured to:
update the first information, where the updated first information is configured to: update the generated first key based on the updated first information when the terminal device reconnects to the SN after disconnecting from a current connection with the SN.

Optionally, in one embodiment of the present disclosure, the device is further configured to:
receive at least one of: an SN identity of at least one SN sent by a master node (MN), or a first counter configured by the MN for the at least one SN; and
determine a second key corresponding to the SN based on at least one of the SN identity or the first counter.

Optionally, in one embodiment of the present disclosure, first counters corresponding to different SNs are the same or different.

Optionally, in one embodiment of the present disclosure, the device is further configured to:
generate a second counter respective for the at least one SN, where a count value of the second counter is updatable by the terminal device.

Optionally, in one embodiment of the present disclosure, second counters corresponding to different SNs are the same or different.

Optionally, in one embodiment of the present disclosure, the first information includes at least one of:
the second key;
the SN identity;
a count value of the first counter; or
the count value of the second counter.

Optionally, in one embodiment of the present disclosure, the device is further configured to:
update the count value of the second counter in response to generating the first key.

Optionally, in one embodiment of the present disclosure, the first information includes at least one of:
a count value of the first counter, where the count value of the first counter is updatable by the terminal device; or
the SN identity.

Optionally, in an embodiment of the present disclosure, the device is further configured to:
update the count value of the first counter in response to generating the first key.

Optionally, in one embodiment of the present disclosure, the device is further configured to:
send the updated count value of the first counter to the MN, in response to updating, by the terminal device, the count value of the first counter.

Optionally, in one embodiment of the present disclosure, the processing module is configured to generate at least one of:
the first key based on the first information before the terminal device releases the connection with the SN; or
the first key based on the first information in a case where a connection release request sent by the SN is received by the terminal device.

Optionally, in one embodiment of the present disclosure, the device is further configured to:
receive an acknowledgment message sent by the SN, where the acknowledgment message indicates that the SN stores the first key.

Optionally, in one embodiment of the present disclosure, the device is further configured to:
send at least one of an identity of the terminal device or key indication information to the SN, where the key indication information instructs the SN to establish the reconnection with the terminal device based on the first key, when the terminal device requests to reconnect to the SN.

Optionally, in one embodiment of the present disclosure, in a case where the current connection between the terminal device and the SN is an initial connection, before generating the first key based on the first information, the device is further configured to:
establish the connection with the SN based on the second key.

Optionally, in one embodiment of the present disclosure, the device is further configured to:
release the current connection with the SN; and
reconnect to the SN.

Optionally, in one embodiment of the present disclosure, the device is further configured to establish at least one of:
the reconnection with the SN based on the first key, in a case where the first counter is configured by the MN to the terminal device before a previous connection between the terminal device and the SN is established; or
the reconnection with the SN based on the second key, in a case where the first counter is configured by the MN to the terminal device after the previous connection between the terminal device and the SN is established, where the second key is determined by the terminal device based on at least one of a count value of the first counter configured by the MN or the SN identity.

Optionally, in one embodiment of the present disclosure, the device is further configured to:
send a reconnection request to the SN, where the reconnection request includes at least one of: an identity of the terminal device, key indication information or second information, where the key indication information instructs the SN to establish the reconnection with the terminal device based on the first key, when the terminal device requests to reconnect to the SN, and the second information is used by the SN to perform integrity verification; and
receive a reconnection success response or a reconnection failure response sent by the SN.

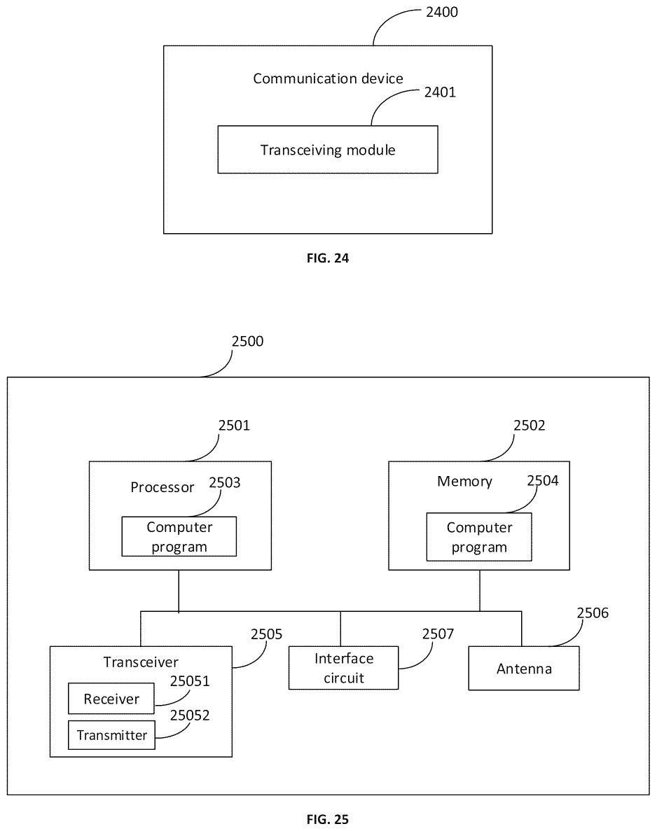

FIG. 24 is a schematic structural diagram of a communication device according to an embodiment of the present disclosure. As shown in FIG. 24, the communication device 2400 can include:
a transceiving module 2401, configured to receive a first key sent by a terminal device in a case where the SN is connected to the terminal device, where the first key may be configured to: establish a reconnection with the terminal device using the first key when the terminal device reconnects to the SN after disconnecting from a current connection with the SN.

In summary, the communication device provided in the embodiment of the present disclosure may be suitable for updating the generated keys configured to connect SNs in a scenario (such as a selective SCG activation scenario) where the SNs are switched for a plurality of times by the terminal device, ensuring stable execution of selective SCG activation.

Optionally, in one embodiment of the present disclosure, the device is further configured to:
receive a second key sent by an MN.

Optionally, in one embodiment of the present disclosure, in a case where the current connection between the terminal device and the SN is an initial connection, before receiving the first key sent by the terminal device, the device is further configured to:
establish the connection with the terminal device based on the second key.

Optionally, in one embodiment of the present disclosure, the device is further configured to:
send a connection release request to the terminal device, where the connection release request is configured to request release of the current connection.

Optionally, in one embodiment of the present disclosure, the device is further configured to:
send an acknowledgment message to the terminal device, where the acknowledgment message indicates that the SN stores the first key.

Optionally, in one embodiment of the present disclosure, the device is further configured to:
receive at least one of an identity of the terminal device or key indication information sent by the terminal device, where the key indication information instructs the SN to establish the reconnection with the terminal device based on the first key, when the terminal device requests to reconnect to the SN.

Optionally, in one embodiment of the present disclosure, the device is further configured to:
release the current connection with the terminal device; and
reconnect to the terminal device.

Optionally, in one embodiment of the present disclosure, the device is further configured to establish at least one of:
the reconnection with the SN based on the first key, in a case where the second key is sent to the SN by the MN before a previous connection between the terminal device and the SN is established; or
the reconnection with the SN based on the second key, in a case where the second key is sent to the SN by the MN after the previous connection between the terminal device and the SN is established.

Optionally, in one embodiment of the present disclosure, the device is further configured to:
receive a reconnection request sent by the terminal device, where the reconnection request includes at least one of: an identity of the terminal device, key indication information or second information, where the key indication information instructs the SN to establish the reconnection with the terminal device based on the first key, when the terminal device requests to reconnect to the SN, and the second information is used by the SN to implement integrity verification; and
obtain processed information by processing the second information based on the first key;
perform integrity verification based on the processed information;
send a reconnection success response to the terminal device, in response to successful integrity verification; or
send a reconnection failure response to the terminal device, in response to failed integrity verification.

Referring to FIG. 25, a schematic structural diagram of a communication device 2500 according to an embodiment of the present disclosure is illustrated. The communication device 2500 may be a network device or a terminal device; or may be a chip, a chip system, a processor, or the like supporting the network device in implementing the foregoing method; or may be a chip, a chip system, a processor, or the like supporting the terminal device in implementing the foregoing method. The device may be configured to implement the method described in the foregoing method embodiments. Details may be referred to description of the foregoing method embodiments.

The communication device 2500 may include one or more processors 2501. The processor 2501 may be a general-purpose processor, a dedicated processor, or the like, such as a baseband processor or a central processing unit. The baseband processor may be configured to process a communication protocol or communication data. The central processing unit may control a communication device (such as a base station, a baseband chip, a terminal device, a terminal device chip, a DU, or a CU, execute a computer program, and process data of the computer program.

Optionally, the communication device 2500 may further include one or more memories 2502 that stores a computer program 2504. The processor 2501 executes the computer program 2504 to enable the communication device 2500 to implement the method described in the foregoing method embodiments. Optionally, the memory 2502 may store data. The communication device 2500 and the memory 2502 may be disposed separately or integrated together.

Optionally, the communication device 2500 may further include a transceiver 2505 and an antenna 2506. The transceiver 2505 may be referred to as a transceiving unit, a transceiver, a transceiving circuit, or the like, and is configured to implement a transceiving function. The transceiver 2505 may include a receiver 25051 and a transmitter 25052. The receiver 25051 may be referred to as a receiving set, a receiving circuit, or the like, and is configured to implement a receiving function. The transmitter 25052 may be referred to as a transmitting set, a transmitting circuit, or the like, and is configured to implement a transmitting function.

Optionally, the communication device 2500 may further include one or more interface circuits 2506. The interface circuit 2506 is configured to receive and transmit code instructions to the processor 2501. The processor 2501 runs the code instructions to enable the communication device 2500 to implement the method described in the foregoing method embodiments.

In an implementation, the processor 2501 may include a transceiver configured to implement receiving and sending functions. For example, the transceiver may be a transceiving circuit, or an interface, or an interface circuit. The transceiving circuit, or interface, or interface circuit configured to implement the receiving and the sending functions may be disposed separately or integrated together. The foregoing transceiving circuit, or interface, or interface circuit may be configured to read and write code/data; or the foregoing transceiving circuit, or interface, or interface circuit may be configured to transmit or transfer a signal.

In an implementation, the processor 2501 may store a computer program 2503. The computer program 2503 runs on the processor 2501, to enable the communication device 2500 to implement the method described in the foregoing method embodiments. The computer program 2503 may be solidified in the processor 2501. In this case, the processor 2501 may be implemented in hardware.

In an implementation, the communication device 2500 may include a circuit. The circuit may implement a sending, or receiving, or communication function in the foregoing method embodiments. The processor and transceiver described in the present disclosure may be implemented on an integrated circuit (IC), an analog IC, a radio frequency integrated circuit RFIC, a mixed signal IC, an application specific integrated circuit (ASIC), a printed circuit board (PCB), an electronic device, or the like. The processor and transceiver may be manufactured using various IC process technologies, for example, a complementary metal oxide semiconductor (CMOS), an n-metal-oxide-semiconductor (NMOS), a positive metal oxide semiconductor (PMOS), a bipolar junction transistor (BJT), a bipolar CMOS (BiCMOS), silicon-germanium (SiGe), gallium arsenide (GaAs), or the like.

The communication device in the foregoing description of embodiments may be a network device or a terminal device. However, the scope of the communication device described in the present disclosure is not limited to these. Moreover, a structure of the communication device may be not limited by FIG. 25. The communication device may be an independent device or may be a portion of a larger device. For example, the communication device may be:
(1) a standalone integrated circuit IC or chip, a chip system, or a sub-system;
(2) a set with one or more ICs; optionally, the IC set may further include a storage component, configured to store data or a computer program;
(3) an ASIC, for example, a modem (Modem);
(4) a module capable of being embedded into other devices;
(5) a receiver, a terminal device, a smart terminal device, a cellular phone, a wireless device, a handset, a mobile unit, an in-vehicle device, a network device, a cloud device, an artificial intelligence device, and the like; or
(6) others.

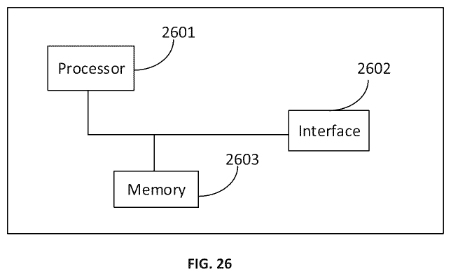

For a case where the communication device may be a chip or a chip system, reference may be made to the schematic structural diagram shown in FIG. 26. The chip shown in FIG. 26 includes a processor 2601 and an interface 2602. Optionally, the device may include one or more processors 2601 and a plurality of interfaces 2602.

Optionally, the chip further includes a memory 2603. The memory 2603 is configured to store needed computer program and data.

As used herein, the term processor may refer to one processor that performs the defined functions or a plurality of processors that collectively perform defined functions, such that the execution of the individual defined functions may be divided amongst such processors.

Those skilled in the art may further understand that various illustrative logical blocks and steps listed in the embodiments of the present disclosure may be implemented via electronic hardware, computer software, or a combination of both. Whether such functions are implemented via hardware or software depends on the specific application and design requirements of the entire system. Those skilled in the art may use various methods to implement the described functions for each particular application, however, such implementation is not construed as extending beyond the protection scope of the embodiments of the present disclosure.

The present disclosure further provides a readable storage medium, storing instructions, where the instructions, when executed by a computer, causes the function of any one of the foregoing method embodiments to be implemented.

The present disclosure further provides a computer program product, where the computer program product, when executed by a computer, causes the function of any one of the foregoing method embodiments to be implemented.

The foregoing embodiments may be implemented entirely or partially via software, hardware, firmware, or any combination of them. The foregoing embodiments may be implemented completely or partially in a form of a computer program product, in response to being implemented using software. The computer program product includes one or more computer programs. When loaded and executed on a computer, the computer program generates, in whole or in part, the processes or functions described in the embodiments of the present disclosure. The computer may be a general-purpose computer, a dedicated computer, a computer network, or other programmable devices. The computer program may be stored in a non-transitory computer-readable storage medium or transmitted from one non-transitory computer-readable storage medium to another non-transitory computer-readable storage medium. For example, the computer program may be transmitted from one website, computer, server, or data center to another website, computer, server, or data center in a wired (for example, a coaxial cable, an optical fiber, and a digital subscriber line (DSL)) manner or a wireless (for example, infrared, wireless, and microwave) manner. The non-transitory computer-readable storage medium may be any usable medium accessible by a computer, or a data storage device such as a server or a data center that integrates one or more usable media. The usable medium may be a magnetic medium (for example, a floppy disk, a hard disk, or a magnetic tape), an optical medium (for example, a digital video disc (DVD)), a semiconductor medium (for example, a solid state disk (SSD)), or the like.

Those of ordinary skill in the art may understand that “first,” “second,” and various numbers in the present disclosure are used merely for distinguishing purposes for ease of description, are not intended to limit the scope of the embodiments of the present disclosure or represent a sequence.

In the present disclosure, “at least one” may also be described as one or more, and “a plurality of” may be two, three, four, or more, which are not specifically limited in the present disclosure. In the embodiments of the present disclosure, technical features of a certain type may be distinguished by terms such as “first,” “second,” “third,” “A,” “B,” “C,” and “D,” where the technical features described by these terms such as “first,” “second,” “third,” “A,” “B,” “C,” and “D” have no sequence of precedence or size.

The corresponding relationships shown in tables of the present disclosure may be configured or pre-defined. Values of signals in the tables are merely for illustrative purposes, and may be configured to other values, which are not limited in the present disclosure. During configuration of the corresponding relationships between information and parameters, all corresponding relationships illustrated in the tables are not needed to be configured. For example, in the tables of the present disclosure, the corresponding relationships shown in some rows may not be configured. For another example, appropriate variations and adjustments, such as splitting or merging, may be made based on the foregoing tables. Names of parameters shown in titles of the foregoing tables may also be other names understandable to the communication device, and values or representations of the parameters may also be in forms understandable to the communication device. During implementation, the foregoing tables may also be represented by other data structures, such as arrays, queues, containers, stacks, linear tables, pointers, linked lists, trees, graphs, structures, classes, heaps, hash tables or other similar structures.

In the present disclosure, the term “pre-defined” may be understood as defined, defined in advance, stored, pre-stored, pre-negotiated, pre-configured, cured, or pre-burned.

Those of ordinary skill in the art may be aware that the units and algorithm steps described in the examples disclosed in this specification may be implemented using electronic hardware or a combination of computer software and electronic hardware. Whether the functions are performed by hardware or software depends on specific applications and design constraints of the technical solutions. Those skilled in the art may use different methods to implement the described functions for each specific applications, however, such the implementation is not construed as extending beyond the scope of the present disclosure.

Those skilled in the art that may clearly understand that, for the sake of convenient and brief description, the specific working process of the foregoing systems, devices, and units may be referred to the corresponding processes in the foregoing method embodiments, which is not repeated here.

The foregoing descriptions are merely specific implementations of the present disclosure, but are not intended to limit the protection scope of the present disclosure. Any variations or substitutions readily figured out by a person skilled in the art within the technical scope disclosed in the present disclosure fall within the protection scope of the present disclosure. As a result, the protection scope of the present disclosure is supposed to be defined by the protection scope of the claims.

1. A method for updating a key, performed by a terminal device, the method comprising:
generating a first key based on first information in a case where the terminal device is connected to a secondary node (SN), wherein the first information is updatable by the terminal device, and the first key is configured to establish a reconnection with the SN using the first key when the terminal device reconnects to the SN after disconnecting from a current connection with the SN; and
sending the first key to the SN.

2. The method according to claim 1, further comprising:
updating the first information, wherein the updated first information is configured to update the generated first key based on the updated first information when the terminal device reconnects to the SN after disconnecting from the current connection with the SN.

3. The method according to claim 2, further comprising:
receiving at least one of the following: an SN identity of at least one SN sent by a master node (MN), or a first counter configured by the MN for the at least one SN; and
determining a second key corresponding to the SN based on at least one of the SN identity or the first counter.

4. (canceled)

5. The method according to claim 3, further comprising:
generating a second counter respectively for the at least one SN, wherein a count value of the second counter is updatable by the terminal device.

6-7. (canceled)

8. The method according to claim 5, wherein updating the first information comprises:
updating the count value of the second counter in response to generating the first key.

9. (canceled)

10. The method according to claim 3, wherein updating the first information comprises:
updating a count value of the first counter in response to generating the first key.

11. The method according to claim 10, further comprising:
sending the updated count value of the first counter to the MN, in response to updating the count value of the first counter by the terminal device.

12. The method according to claim 1, wherein generating the first key based on the first information comprises at least one of the following:
generating the first key based on the first information before the terminal device releases the current connection with the SN;
generating the first key based on the first information in a case where a connection release request sent by the SN is received by the terminal device
receiving an acknowledgment message sent by the SN, wherein the acknowledgment message indicates that the SN stores the first key; or
sending at least one of an identity of the terminal device or key indication information to the SN, wherein the key indication information instructs the SN to establish the reconnection with the terminal device based on the first key, when the terminal device requests to reconnect to the SN.

13-14. (canceled)

15. The method according to claim 3, wherein before generating the first key based on the first information, in a case where the current connection between the terminal device and the SN is an initial connection, the method further comprises:
establishing a connection with the SN based on the second key.

16. The method according to claim 3, further comprising:
releasing the current connection with the SN; and
reconnecting to the SN,
wherein reconnecting to the SN comprises at least one of the following:
establishing the reconnection with the SN based on the first key, in a case where the first counter is configured by the MN to the terminal device before a previous connection between the terminal device and the SN is established; or
establishing the reconnection with the SN based on the second key, in a case where the first counter is configured by the MN to the terminal device after the previous connection between the terminal device and the SN is established, wherein the second key is determined by the terminal device based on at least one of a count value of the first counter configured by the MN or the SN identity.

17. (canceled)

18. The method according to claim 16, wherein establishing the reconnection with the SN based on the first key comprises:
sending a reconnection request to the SN, wherein the reconnection request comprises at least one of the following: an identity of the terminal device, key indication information, or second information, wherein the key indication information instructs the SN to establish the reconnection with the terminal device based on the first key when the terminal device requests to reconnect to the SN, and the second information is used by the SN to perform integrity verification; and
receiving a reconnection success response or a reconnection failure response sent by the SN.

19. A method for updating a key, performed by a secondary node (SN), comprising:
receiving a first key sent by a terminal device in a case where the SN is connected to the terminal device, wherein the first key is configured to: establish a reconnection with the terminal device using the first key when the terminal device reconnects to the SN after disconnecting from a current connection with the SN.

20. The method according to claim 19, further comprising at least one of the following:
receiving a second key sent by a master node (MN);
sending a connection release request to the terminal device, wherein the connection release request is configured to request release of the current connection;
sending an acknowledgment message to the terminal device, wherein the acknowledgment message indicates that the SN stores the first key; or
receiving at least one of an identity of the terminal device or key indication information sent by the terminal device, wherein the key indication information instructs the SN to establish the reconnection with the terminal device based on the first key when the terminal device requests to reconnect to the SN.

21. The method according to claim 19, further comprising, before receiving the first key sent by the terminal device, in a case where the current connection between the terminal device and the SN is an initial connection:
establishing a connection with the terminal device based on a second key.

22-24. (canceled)

25. The method according to claim 20, further comprising:
releasing the current connection with the terminal device; and
reconnecting to the terminal device,
wherein reconnecting to the terminal device comprises at least one of the following:
establishing the reconnection with the SN based on the first key, in a case where the second key is sent to the SN by the MN before a previous connection between the terminal device and the SN is established; or
establishing the reconnection with the SN based on the second key, in a case where the second key is sent to the SN by the MN after the previous connection between the terminal device and the SN is established.

26. (canceled)

27. The method according to claim 25, wherein establishing the reconnection with the SN based on the first key comprises:
receiving a reconnection request sent by the terminal device, wherein the reconnection request comprises at least one of the following: an identity of the terminal device; key indication information, or second information, wherein the key indication information instructs the SN to establish the reconnection with the terminal device based on the first key when the terminal device requests to reconnect to the SN, and the second information is used by the SN to perform integrity verification;
obtaining processed information by processing the second information based on the first key;
performing integrity verification based on the processed information;
sending a reconnection success response to the terminal device in response to successful integrity verification; and
sending a reconnection failure response to the terminal device in response to failed integrity verification.

28-29. (canceled)

30. A communication device, comprising:
one or more processors; and
a memory that stores a computer program,
wherein the one or more processors are collectively configured to execute the computer program stored in the memory to enable the communication device to implement:
generating a first key based on first information in a case where a terminal device is connected to a secondary node (SN), wherein the first information is updatable by the terminal device, and the first key is configured to: establish a reconnection with the SN using the first key when the terminal device reconnects to the SN after disconnecting from a current connection with the SN; and
sending the first key to the SN.

31. (canceled)

32. A non-transitory computer-readable storage medium storing instructions, wherein the instructions, when executed by one or more processors, cause the one or more processors to perform the method according to claim 1.

33. A communication device, comprising:
one or more processors; and
a memory that stores a computer program,
wherein one or more processors are collectively configured to execute the computer program stored in the memory to enable the communication device to implement the method according to claim 19.

34. A non-transitory computer-readable storage medium storing instructions, wherein the instructions, when executed by one or more processors, cause the one or more processors to perform the method according to claim 19.
